(19) United States
(12) Patent Application Publication
(10) Pub. No.: US 2025/0138236 A1
(43) Pub. Date: May 1, 2025

(54) OPTICAL MEMBER, METHOD FOR PRODUCING SAME, AND OPTICAL ELEMENT

(71) Applicant: NITTO DENKO CORPORATION, Osaka (JP)

(72) Inventors: Kenjiro SAOMOTO, Osaka (JP); Naoyuki MATSUO, Osaka (JP)

(73) Assignee: NITTO DENKO CORPORATION, Osaka (JP)

(21) Appl. No.: 18/729,307

(22) PCT Filed: Jan. 13, 2023
(86) PCT No.: PCT/JP2023/000809

§ 371 Date: Dec. 30, 2024

(30) Foreign Application Priority Data
Jan. 20, 2022 (JP) 2022-007153

(51) Int. Cl. F21V 8/00; G02B 1/04

(52) U.S. Cl. CPC G02B 6/0065; G02B 1/048; G02B 6/0018; G02B 6/0035; G02B 6/0036; G02B 6/0076; G02B 1/046

(57) ABSTRACT

This optical member has a first layer with a porous structure, the first layer includes a first area with the porous structure and a second area in which the pores of the porous structure are filled with a resin composition, the second area includes a plurality of discretely arranged island-like areas, and when the area ratio of the first layer occupied by the second area is denoted by P % and the haze value of the first layer is denoted by H %, H/P is less than 0.20.

### TECHNICAL FIELD

The present disclosure relates to an optical member, a method for producing the same, and an optical element.

### BACKGROUND ART

As a method for retrieving light from a waveguide layer, a method using an optical extraction layer including two regions having different refractive indices from each other is known (e.g., Patent Document No. 1).

According to Patent Document No. 1, for example, a pressure-sensitive adhesive layer is formed on a porous layer, the pressure-sensitive adhesive layer is irradiated with laser light with a predetermined pattern, and pores in the porous layer are filled with the melted pressure-sensitive adhesive. As a result, a light extraction layer in which a low refractive index region having the pores remaining and a high refractive index region having the pores filled with the pressure-sensitive adhesive are positionally arranged with a predetermined pattern is formed.

The entirety of Patent Document No. 1 is incorporated herein by reference. In this specification, the light extraction layer in Patent Document No. 1 may be referred to as a “light coupling layer”, and “extraction of light” in Patent Document No. 1 may be referred to as “retrieval of light” or “coupling of light”.

Patent Documents Nos. 2 and 3 each discloses a method for forming a light extraction layer as follows. On a nanovoid polymeric layer, an additional material is provided by printing such that the additional material enters the nanovoid polymer layer, and thus a region to which the additional material has entered and a region to which the additional material has not entered are formed. As a result, a light extraction layer including regions having different refractive indices from each other is formed.

### CITATION LIST

### Patent Literature

Patent Document No. 1: WO2019/182100

Patent Document No. 2: United States Patent Application Publication No. 2015330597

Patent Document No. 3: United States Patent Application Publication No. 20170031078

### SUMMARY OF INVENTION

### Technical Problem

However, according to the studies made by the present inventors, there were cases where it was difficult, with the method using the irradiation with the laser light as described in Patent Document No. 1, to form, for example, a relatively high-definition pattern with high efficiency. Even with the method described in each of Patent Documents Nos. 2 and 3, there were cases where it was difficult to form regions having different refractive indices from each other with a designed pattern correctly.

Thus, the present invention has an object of providing a method for forming regions having different refractive indices from each other with a designed pattern more correctly than with the conventional art, and to provide an optical member including such an optical layer.

### Solution to Problem

Embodiments of the present invention provide the solutions described in the following items.

### Item 1

An optical member, comprising:
a first layer having a porous structure,
wherein the first layer includes a first region having the porous structure and a second region formed of a resin composition filling pores included in the porous structure,
wherein the second region includes a plurality of island-like regions discretely located, and
wherein where the second region occupies an area size ratio of P % of the first layer and the first layer has a Haze value of H %, an H/P value is smaller than 0.20.

### Item 2

The optical member of item 1, wherein a diameter of a circle having an equal circumference to that of each of the plurality of island-like regions is about 1 μm or longer and about 500 μm or shorter.

### Item 3

The optical member of item 1 or 2, wherein the resin composition contains a curable resin composition in a cured state.

### Item 4

The optical member of item 3, wherein the resin composition contains a polyfunctional silicon compound.

### Item 5

The optical member of item 3, wherein the resin composition contains an acrylic resin.

### Item 6

The optical member of any one of items 3 through 5, wherein the resin composition further contains a solvent.

### Item 7

The optical member of any one of items 1 through 6, further comprising a second layer in contact with a first main surface of the first layer, wherein where the first region has a refractive index of n₁, the second region has a refractive index of n₂ and the second layer has a refractive index of n₃, n₁<n₂ and n₁<n₃.

### Item 8

The optical member of item 7, wherein n₁ is 1.30 or lower, and n₂ is 1.43 or higher.

### Item 9

The optical member of item 7 or 8, wherein the second layer is an adhesive layer or a substrate layer.

### Item 10

The optical member of any one of items 1 through 9, wherein the first layer contains a porous silica material.

### Item 11

An optical element, comprising:
the optical member of any one of items 1 through 10; and a waveguide layer.

### Item 12

The optical element of item 11, further comprising a direction conversion layer located on a side opposite to the waveguide layer across the optical member.

### Item 13

A method for producing an optical member, comprising:
step A of preparing a porous layer;
step B of forming a plurality of discrete island-like regions of a solution Sa, containing a curable resin composition, on the porous layer, the solution Sa having a concentration higher than 60 mass % and lower than 99 mass %;
step C of filling pores included in the porous layer with the solution Sa; and
step D of curing the curable resin composition contained in the solution Sa in the pores.

### Item 14

The method for producing the optical member of item 13, wherein the step B includes step BS1 of forming the plurality of discrete island-like regions of the solution Sa on a film, and step BS2 of transferring the solution Sa on the film onto the porous layer.

### Item 15

The method for producing the optical member of item 14, wherein the step BS2 is performed at a laminate pressure of 0.3 MPa or lower.

### Item 16

The method for producing the optical member of item 13, wherein the step B includes step BS1 of forming the plurality of discrete island-like regions of the solution Sa on an adhesive layer, and step BS2 of transferring the solution Sa on the adhesive layer onto the porous layer.

### Item 17

The method for producing the optical member of item 16, wherein the step BS1 includes step BS3 of forming the plurality of discrete island-like regions of the solution Sa on a film, and step BS4 of transferring the solution Sa on the film onto the adhesive layer.

### Item 18

The method for producing the optical member of any one of items 13 through 17, wherein the step of forming the plurality of discrete island-like regions of the solution Sa includes a step of forming the plurality of discrete island-like regions of a solution Sb containing the curable resin composition at a concentration of 60 mass % or lower, and a step of removing a part of a solvent contained in the solution Sb.

### Advantageous Effects of Invention

Embodiments of the present invention provide a method for forming a light extraction layer having a relatively high-definition pattern more correctly than with the conventional art, and also provide an optical member including such a light extraction layer, a method for producing the same, and an optical element including such an optical member.

### BRIEF DESCRIPTION OF DRAWINGS

FIG. 1 is a schematic cross-sectional view of an optical element 100 including an optical member according to an embodiment of the present invention.

FIG. 2 is a schematic plan view showing an example of a positional arrangement of a first region 12 and a second region 14 in a first layer 10 included in the optical member according to an embodiment of the present invention.

FIG. 3A is a schematic cross-sectional view showing one step of a process for producing the optical member 100.

FIG. 3B is a schematic cross-sectional view showing one step of the process for producing the optical member 100.

FIG. 3C is a schematic cross-sectional view showing one step of the process for producing the optical member 100.

FIG. 3D is a schematic cross-sectional view showing one step of the process for producing the optical member 100.

FIG. 3E is a schematic cross-sectional view showing one step of the process for producing the optical member 100.

FIG. 4A shows an optical microscopic image of sample No. 7.

FIG. 4B shows an optical microscopic image of sample No. 8.

FIG. 4C shows an optical microscopic image of sample No. 9.

FIG. 5A shows an optical microscopic image of sample No. 10.

FIG. 5B shows an optical microscopic image of sample No. 11.

FIG. 5C shows an optical microscopic image of sample No. 12.

FIG. 6 is a graph showing the relationship between the concentration of a solution Sa and the Haze value H/area size ratio P.

FIG. 7 is a schematic cross-sectional view of an optical element 200A according to an embodiment of the present invention.

FIG. 8 is a schematic cross-sectional view of an optical element 200B.

FIG. 9 is a schematic cross-sectional view of an optical element 200C.

FIG. 10A is a schematic plan view of a patterned film 70.

FIG. 10B is a schematic cross-sectional view showing concaved portions 74 of the patterned film 70.

### DESCRIPTION OF EMBODIMENTS

Hereinafter, an optical member, a method for producing the optical member, and an optical element including the optical member according to an embodiment of the present invention will be described with reference to the drawings. Embodiments of the present invention are not limited to the embodiments described below.

FIG. 1 is a schematic cross-sectional view of an optical element 100 including an optical member according to an embodiment of the present invention. The optical member according to an embodiment of the present invention includes a first layer 10 having a porous structure. The optical member may include the first layer 10 and a substrate layer 30, or may include the first layer 10 and an adhesive layer 20. The optical member according to an embodiment of the present invention includes at least the first layer 10.

The optical member according to an embodiment of the present invention may, for example, extract light propagating in a waveguide layer from a main surface of the waveguide layer, or guide the light propagating in the waveguide layer toward an optical member located to be in contact with the main surface of the waveguide layer. Guiding the light propagating in the waveguide layer toward the optical member located to be in contact with the main surface of the waveguide layer will be referred to as “optically coupling the light”, and a layer acting to couple the light will be referred to as a “light coupling layer”. For example, the optical member according to an embodiment of the present invention is preferably usable as, for example, a light coupling layer included in a waveguide member described in Japanese Patent Application No. 2020-127530 (filing date: Jul. 28, 2020) filed by the present Applicant. As described in the above-mentioned patent application, the light coupling layer may be provided between a waveguide layer and a direction conversion layer. The direction conversion layer includes, for example, a plurality of inner spaces that form an interface that directs light toward a main surface of the direction conversion layer by total internal reflection. Such a direction conversion layer having the inner spaces may be, for example, a light distribution structure disclosed in WO2019/087118. Alternatively, the direction conversion layer may be a known prism sheet. The entirety of Japanese Patent Application No. 2020-127530 and the entirety of WO2019/087118 are incorporated herein by reference.

The optical element 100 includes the first layer 10, a waveguide layer 50, the adhesive layer 20 provided between the first layer 10 and the waveguide layer 50, and the substrate layer 30 supporting the first layer 10. As described below, the first layer 10 described herein as an example is formed on the substrate layer 30.

The first layer 10 includes a first region 12 having a porous structure and a second region 14 formed of a resin composition filling pores included in the porous structure. The second region 14 includes a plurality of island-like regions discretely located. As described below by way of examples, the first layer 10 has a feature of having an H/P value smaller than 0.20, where the second region 14 occupies an area size ratio of P % of the first layer 10, and the first layer 10 has a Haze value of H %. For example, the area size ratio P is found for an area of, for example, 10 mm ×10 mm centering around a point for which the Haze value is to be measured.

It is now assumed that a layer in contact with a first main surface of the first layer 10 is a second layer (the adhesive layer 20 in this example). Where the first region 12 has a refractive index of n₁, the second region 14 has a refractive index of n₂ and the second layer 20 has a refractive index of n₃, n₁<n₂ and n₁<n₃. At this point, for example, the relationship of n₂<n₃ is fulfilled. n₁ may be, for example, 1.30 or lower, n₂ may be, for example, 1.43 or higher, and n₃ may be, for example, 1.45 or higher.

The first layer 10 may be formed of, for example, a porous silica material. The porous silica material has a porosity that is higher than 0% and lower than 100%. In order to provide a low refractive index, the porosity is preferably 40% or higher, more preferably 50% or higher and still more preferably 55% or higher. There is no specific upper limit on the porosity, but the porosity is preferably 95% or lower and more preferably 85% or lower from the point of view of strength.

Silica (matrix portion of the porous silica material) preferably has a refractive index of, for example, 1.41 or higher and 1.43 or lower. The resin composition filling the pores of the first layer 10 is a curable resin composition that has been cured (may be referred to as a “cured resin composition”). It is preferred that the curable resin composition is a photocurable resin composition from the point of view of mass productivity. The photocurable resin composition is, for example, a polyfunctional silicon compound (e.g., a silsesquioxane derivative: a compound including a silsesquioxane framework and a plurality of photocurable functional groups bonded thereto) or an acrylic resin (e.g., urethane acrylate). A general resin has a refractive index of generally 1.45 or higher and 1.70 or lower. The porosity of the porous structure and the refractive index n₃ of the cured resin composition included in the first layer 10 are adjusted, so that it is possible to control the refractive index n₂ of the second region 14. It is preferred that |n₂−n₃|is 0.1 or smaller. With such a relationship of n₂ and n₃, an occurrence of total internal reflection at an interface between the second layer 20 and the second region 14 of the first layer 10 may be suppressed.

The first region 12 and the second region 14 are located with a predetermined pattern, and as a result, the first layer 10 acting as, for example, a light coupling layer is provided. The light coupling layer is located between two optical layers, for example, between a waveguide layer and a direction conversion layer to guide a part of light propagating in the waveguide layer toward the direction conversion layer. The direction conversion layer includes, for example, an interface (or a surface) that provides the propagating light with a component in a direction normal to the layer. The direction conversion layer may be, for example, a prism sheet.

With reference to FIG. 1 again, functions of the optical element 100 according to an embodiment of the present invention will be described.

The first layer 10, the adhesive layer 20, the waveguide layer 50 and the substrate layer 30 of the optical element 100 are each assumed to have a main surface parallel to an XY plane. Light emitted from a light source LS toward a light receiving end surface (not shown) of the waveguide layer 50 is propagated in the waveguide layer 50 in a Y direction (waveguide light Lₚ). A part of the light incident on the waveguide layer 50 is optically coupled with the substrate layer 30 (extracted toward the substrate layer 30) by the first layer 10 and the adhesive layer 20 (optical member) and is output in a Z direction (output light L_{E}). Needless to say, the direction in which the light is propagated is dispersed (distributed) from the Y direction, and the direction in which the light is output is dispersed (distributed) from the Z direction. An X direction crosses the Y direction and the Z direction perpendicularly.

The light Lₚ propagated in the waveguide layer 50 is subjected to total internal reflection at an interface between the second layer 20 and the first region 12 of the first layer 10, whereas the light incident on the interface between the second layer 20 and the second region 14 of the first layer 10 passes the second region 14 of the first layer 10 and the substrate layer 30 without being subjected to total internal reflection, and is output from the optical element 100.

The positional arrangement of the first region 12 and the second region 14 in the first layer 10 in a layer plane (the layer plane is parallel to the XY plane) is adjusted, so that it is possible to control the light distribution (the output intensity distribution, the output angle distribution, etc.) of the light extracted from the waveguide layer 50 (optically coupled with the substrate layer 30) by an optical member. The positional arrangement of the first region 12 and the second region 14 in the first layer 10 is appropriately set in accordance with the required light distribution. Therefore, a desired light distribution is not provided unless the second region 14 is formed with a designed pattern.

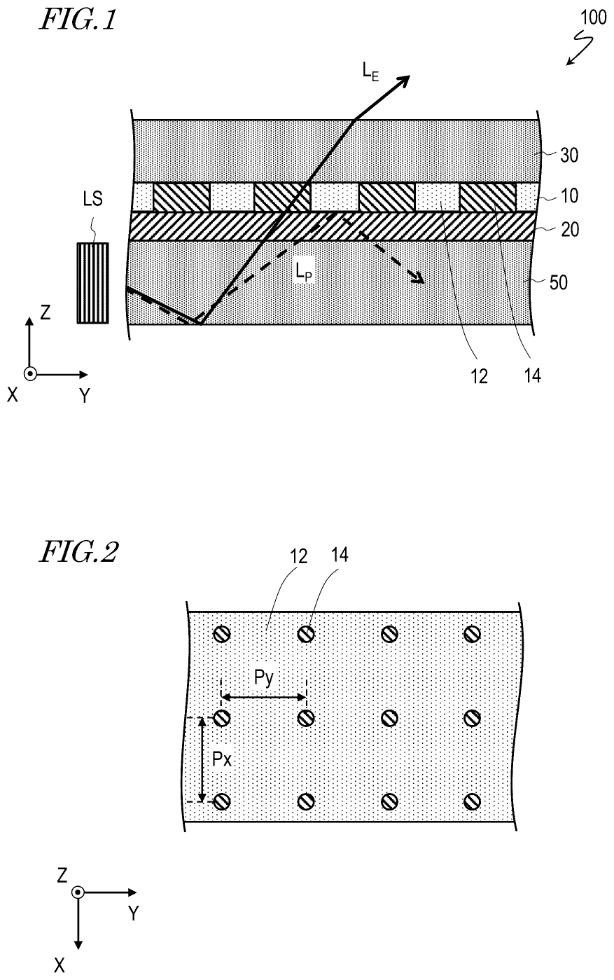

As shown in FIG. 2, the first layer 10, for example, includes a plurality of circular second regions 14 discretely located in the first region 12. The second regions 14 each have a diameter of, for example, about 1 μm or longer and about 500 μm or shorter. Pitch Px between the second regions 14 adjacent to each other in the X direction, and pitch Py between the second regions 14 adjacent to each other in the Y direction, are each independent, for example, about 2 μm or longer and about 5000 μm or shorter. The pitches Px and Py are each a distance between centers (area centroids) of the second regions 14 adjacent to each other in the X direction or the Y direction.

The positional arrangement of the first region 10 and the second region 14 in the first layer 10 may be modified in any of various manners. Each of the second regions 14 is not limited to being circular, and may have any of various shapes.

The shape and the size of the second region 14, the density of the second region 14 with respect to the plane of the first layer 10, and the occupancy ratio of the second region 14 with respect to the first layer 10 may be appropriately changed in accordance with the purpose or use of the optical member. In the case where, for example, a good visual recognizability such as a high transparency is required, each of the second regions 14 has a longer diameter that is preferably 100 μm or shorter and more preferably 70 μm or shorter. In the case where, for example, the second region 14 is circular as shown in FIG. 2, it is preferred that the diameter of each circular island of the second region 14 is 100 μm or shorter. Such a diameter allows visual recognition of the second region 14 to be suppressed in the case where a device including the optical member is used in a mobile display, compact signage or the like, which is observed at a relatively short distance. In the case where the islands of the second region 14 are not circular, the evaluation may be made with a diameter of a circle having an equal circumference to that of each of the islands of the second region 14.

Now, a method for producing an optical member including the first layer 10 according to an embodiment of the present invention will be described. The first layer 10 has a feature of having an H/P value smaller than 0.20, where P % is the area size ratio occupied by the second region 14 with respect to the first layer 10 and H % is the Haze value of the first layer 10. If the H/P is larger 0.20%, a desired light distribution characteristic may not be provided due to an influence of diffused light (light scattering from areas around the islands of the second region 14).

An optical member including the first layer 10 having the above-described feature may be produced by, for example, a method described below.

A method for producing an optical member according to an embodiment of the present invention includes step A of preparing a porous layer, step B of forming a plurality of discrete island-like regions of a solution Sa containing a curable resin composition on the porous layer, the solution Sa having a concentration that is higher than 60 mass %, step C of filling pores included in the porous layer with the solution Sa, and step D of curing the curable resin composition contained in the solution Sa in the pores. The curable resin composition, in the case of being a photocurable resin composition, may be cured by, for example, being irradiated with ultraviolet rays.

The step B includes, for example, step BS1 of forming the plurality of discrete island-like regions of the solution Sa on a film, and step BS2 of transferring the solution Sa on the film onto the porous layer. It is preferred that the step BS2 is performed at a laminate pressure of 0.3 MPa or lower. Alternatively, the step B may include, for example, step BS1 of forming the plurality of discrete island-like regions of the solution Sa on an adhesive layer, and step BS2 of transferring the solution Sa on the adhesive layer onto the porous layer. The step BS1 may further include, for example, step BS3 of forming the plurality of discrete island-like regions on the film, and step BS4 of transferring the solution Sa on the film onto the adhesive layer.

The step of forming the plurality of discrete island-like regions of the solution Sa may include a step of forming the plurality of discrete island-like regions of a solution Sb containing a curable resin composition at a concentration of 60 mass % or lower, and a step of removing a part of a solvent contained in the solution Sb.

The step of forming the plurality of discrete island-like regions of the solution Sb containing the curable resin composition at a concentration of 60 mass % or lower may be performed by, for example, any of various printing methods. A gravure printing method, by which a solution Sb having a viscosity of 0.1 to 1 Pa·s is usable, is preferred to an inkjet method or the like, by which only a solution Sb having a relatively low viscosity is usable. The curable resin composition (e.g., a silsesquioxane derivative or an acrylic resin) is a liquid. From the point of view of ease of coating at the time of gravure printing or ease of filling the pores of the porous structure (ease of permeation or ease of entering), it is preferred that the curable resin composition is used as a solution after being diluted with a solvent (e.g., an organic solvent such as alcohol, toluene or the like). The step of removing a part of the solvent contained in the solution Sb is performed by, for example, heating the film (adhesive layer or substrate layer) on which the plurality of discrete island-like regions are formed of the solution Sb.

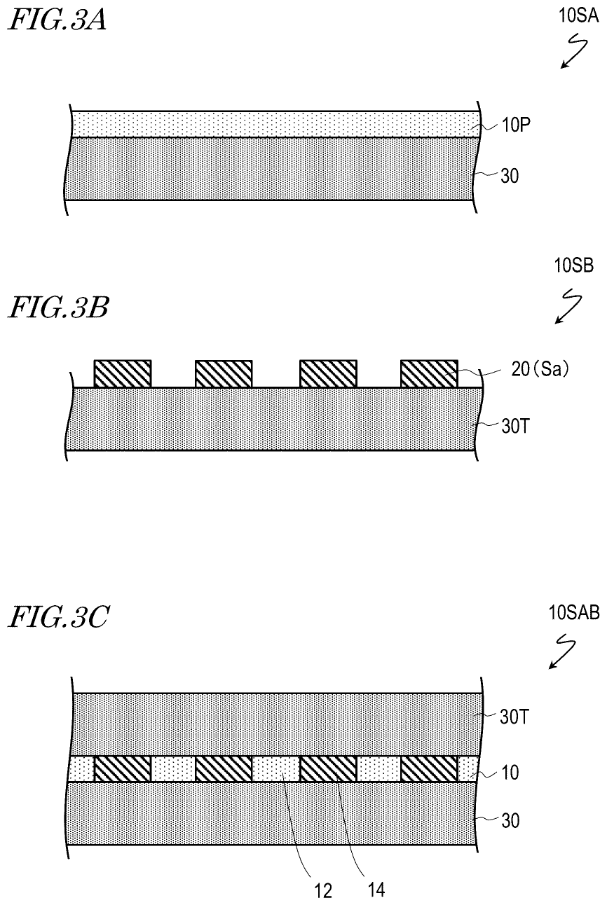

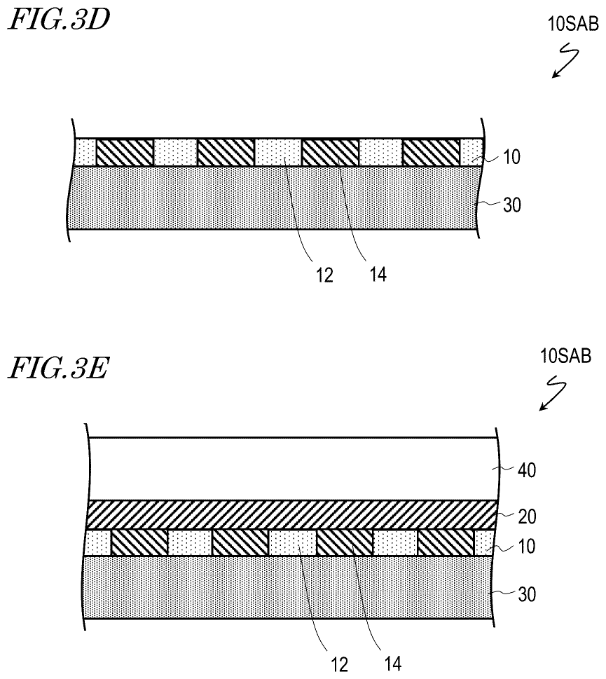

Now, with reference to FIG. 3A through FIG. 3E, a specific example of the method for producing the optical member will be described.

First, as shown in FIG. 3A, a layer 10P having a porous structure is formed on the substrate layer 30. The porous layer 10P may be formed by, for example, a method described below as an example. A component including the layer 10P, which is to be the first layer 10, is represented by reference sign 10SA. The configuration will change as the steps proceed, but the same reference sign will be used.

Separately, as shown in FIG. 3B, a plurality of discrete island-like regions are formed of the solution Sb, containing a curable resin composition at a concentration of 60 mass % or lower, on a transfer substrate (e.g., PET) 30T by, for example, a gravure printing method. For example, a gravure plate (in which circular cells each have a diameter of 50 μm and a depth of 8 μm, and the cell pitches Px and Py are each 200 μm) is used to form the pattern shown in FIG. 2. In the pattern formed of the solution Sb, the circular island-like regions each have a diameter of about 100 μm. A gravure roll has a diameter of 130 mm and a width of 110 mm. The printing is performed on a circumferential surface of the roll at a printing rate of 14 m/min. and an impression cylinder nip pressure of 0.86 MPa. A component including the curable resin composition is represented with reference sign 10SB. The configuration will change as the steps proceed, but the same reference sign will be used.

The component 10SB is dried to remove a part of the solvent contained in the solution Sb. As a result, the solution Sa is obtained. In this manner, the plurality of discrete island-like regions formed of the solution Sa containing the curable resin composition is obtained.

Next, as shown in FIG. 3C, the plurality of discrete island-like regions formed of the solution Sa containing the curable resin composition are transferred onto the layer 10P of the component 10SA. The pores of the porous structure of the layer 10P of the component 10SA are filled with the solution Sa. Then, ultraviolet rays are directed from the side of the substrate 30 (e.g., fusion UV is directed such that UVA wavelength exposure is 600 mJ/cm² (lamp: V bulb)) to cure the curable resin composition. As a result, regions corresponding to the plurality of discrete island-like regions formed of the solution Sa containing the curable resin composition become islands of the second region, and the rest of the layer 10P becomes the first region. Thus, the first layer 10 is obtained. At this point, a layer not containing the curable resin composition may be formed in an area of the first layer 10 on the side close to the substrate 30 or on the opposite side (the first region may exist continuously), in the case where, for example, the solution Sa forming the island-like regions is of a certain amount. A component including the component 10SA and the component 10SB is represented with reference sign 10SAB.

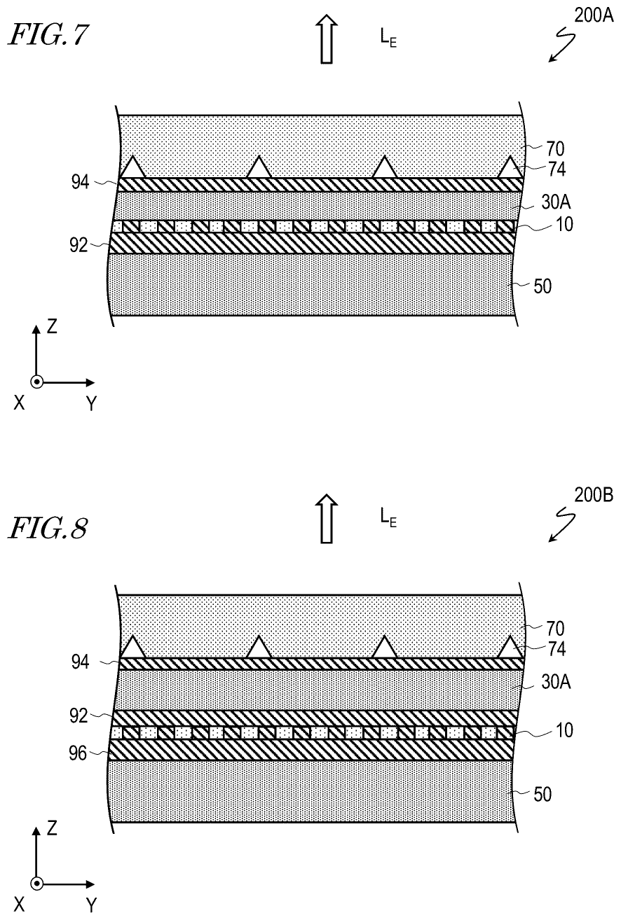

Next, as shown in FIG. 3D, the transfer substrate 30T is delaminated, and as shown in FIG. 3E, the adhesive layer 20 formed on a release sheet 40 is bonded to the first layer 10. The release sheet 40 of the component 10SAB is delaminated and the remaining part is bonded to another optical element. As a result, an optical element (e.g., an optical element 200A shown in FIG. 7) is obtained.

In this embodiment, the plurality of discrete island-like regions are formed of the solution Sb, containing the curable resin composition at a concentration of 60 mass % or lower, on the transfer substrate 30T. Alternatively, the plurality of discrete island-like regions may be formed on the adhesive layer. Still alternatively, the plurality of discrete island-like regions may be formed of the solution Sb, containing the curable resin composition at a concentration of 60 mass % or lower, on the transfer substrate 30T and transferred to the adhesive layer, and then the plurality of discrete island-like regions formed of the solution Sa containing the curable resin composition may be transferred onto the layer 10P of the component 10SA. Still alternatively, the solution Sa containing the curable resin composition may be provided directly to the layer 10P of the component 10SA so as to form the plurality of discrete island-like regions.

Regarding the above-described method, in the step of forming the plurality of discrete island-like regions of the solution Sa, containing the curable resin composition, on the porous layer, it is important that the concentration of the solution Sa is higher than 60 mass %. This will be explained by way of experiment examples.

In this embodiment, the following two solutions were prepared as the solution Sb.

### First Solution

A: TX100 (silsesquioxane derivative; Toagosei Co., Ltd.) 90 parts
B: Ceroxide (alicyclic bifunctional epoxy; Daicel Corporation) 10 parts
C: CPI101 (cationic initiator; San-Apro Ltd.) 5 parts
Then, D: isobutylalcohol was added and diluted such that the concentration of (A+B+C) would be 70 mass %. Then, the resultant substance was mixed by a stirrer to be uniform.

### Second Solution

A and B were blended so as to have the following parts.
A: UV-1700TL (mixture of polyurethaneacrylate+ester acrylate+toluene, solid content: 80% by weight; Mitsubishi Chemical Holdings Corporation) 100 parts
B: Omirad184 (photopolymerization initiator; BASF) 3 parts
Then, C: toluene was added and diluted such that the concentration of (A+B+C) would be 60 mass %. Then, the resultant substance was mixed by a stirrer to be uniform.

The solution Sb was dried under different conditions (not dried, dried at 80° C. for 2 minutes, dried at 80° C. for 5 minutes), and as a result, solutions Sa having different concentrations were obtained. The first solution and the second solution were used to produce samples Nos. 1 through 6 by the method described above as an example with reference to FIG. 3A through FIG. 3E, the cell pitches Px and Py each being 150 μm. Samples Nos. 7 through 12, which were respectively the same as samples Nos. 1 through 6 except that the cell pitches Px and Py were each 200 μm, were also produced. Sample No. 13 was also produced, in which the solution Sa had a concentration of 99 mass %. (See Table 1 below.)

It has been found out that the forms of the islands of the second region in the first layer 10 formed on the acrylic plate were different in accordance with the concentration of the solution Sa.

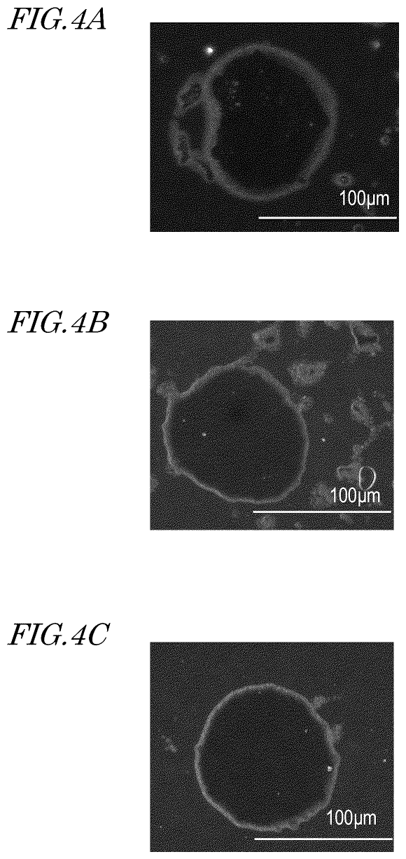

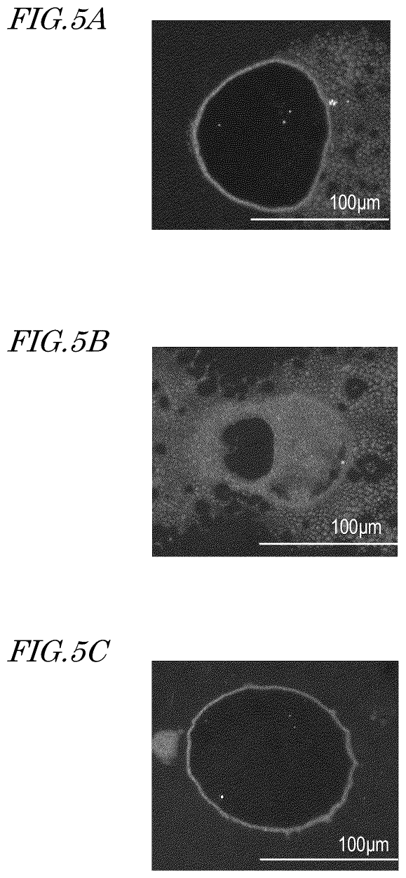

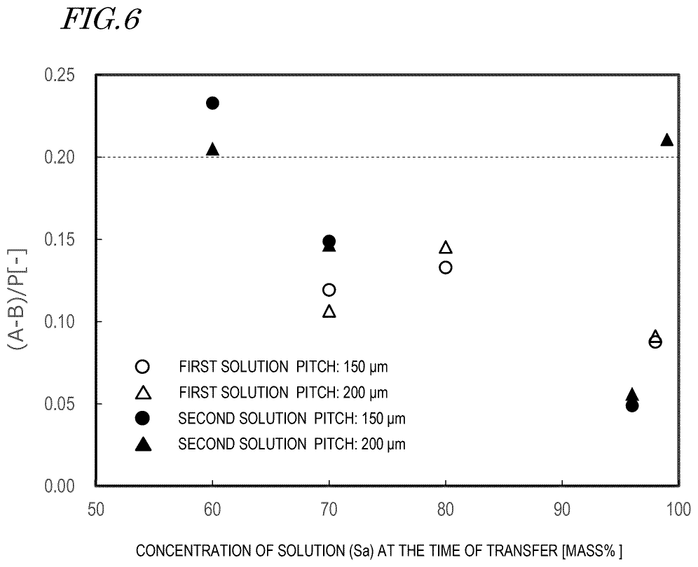

FIG. 4A through FIG. 4C respectively show optical microscopic images of samples Nos. 7 through 9 formed by the use of the first solution. FIG. 5A through FIG. 5C respectively show optical microscopic images of samples Nos. 10 through 12 formed by use of the second solution. FIG. 4A through FIG. 4C each show that there is a white area, caused by scattering of light, around the island of the second region (dark area) that is substantially circular (diameter: about 100 μm). When the light scatters, a desired light distribution characteristic may not be obtained. Therefore, it is preferred that the area size of the white area in each of the figures is small. It is seen that as the concentration of the solution Sa is higher, the area size of the white area is smaller.

With reference to FIG. 5A through FIG. 5C, it is seen that the area size of the white area is especially large in sample No. 11 shown in FIG. 5B.

The degree to which these white areas have an adverse influence on the optical characteristics was evaluated with the Haze value (numerical value of diffuse transmittance/total transmittance represented by the percentage). The Haze value was measured by use of a Haze meter (HM-150N produced by Murakami Color Research Laboratory Co., Ltd.) by a method compliant with JIS K 7136. The results are shown in Table 1. Haze value Ha represents the Haze value obtained by measuring the first layer 10 on the acrylic plate. Haze value H represents the value obtained by subtracting the Haze value Hb of the acrylic plate itself (0.4325) from the Haze value Ha (Haze value H=Ha−Hb). Area size ratio P represents the area size ratio (designed value) occupied by the second region 14 with respect to the first layer 10. In samples Nos. 1 through 6, the area size ratio P was 34.91%.

In samples Nos. 7 through 13, the area size ratio P was 19.63%. The Haze value H/area size ratio P is a parameter that represents the contribution of the second region 14 to the rise in the Haze value. FIG. 6 is a graph showing the relationship between the concentration of the solution Sa and the Haze value H/area size ratio P.

TABLE 1

| | | | | | HAZE |
|---|---|---|---|---|---|
| | | | | | VALUE |
| | | | | | H/ |
| | | | | | AREA |
| | | | SOLUTION Sa | HAZE | SIZE |
| SAMPLE | | | CONCENTRATION/ | VALUE | RATIO |
| NO. | SOLUTION/PITCH | | MASS % | Ha/% | P |
| 1 | FIRST/150 | μm | 70 | 4.597 | 0.119 |
| 2 | FIRST/150 | μm | 80 | 5.070 | 0.133 |
| 3 | FIRST/150 | μm | 98 | 3.490 | 0.088 |
| 4 | SECOND/150 | μm | 70 | 5.627 | 0.149 |
| 5 | SECOND 150 | μm | 60 | 8.560 | 0.233 |
| 6 | SECOND/150 | μm | 96 | 2.140 | 0.049 |
| 7 | FIRST/200 | μm | 70 | 2.523 | 0.106 |
| 8 | FIRST/200 | μm | 80 | 3.287 | 0.145 |
| 9 | FIRST/200 | μm | 98 | 2.223 | 0.091 |
| 10 | SECOND/200 | μm | 70 | 3.310 | 0.147 |
| 11 | SECOND/200 | μm | 60 | 4.457 | 0.205 |
| 12 | SECOND/200 | μm | 96 | 1.530 | 0.056 |
| 13 | SECOND/200 | μm | 99 | 4.567 | 0.211 |

As can be seen from the results shown in Table 1 and FIG. 6, sample No. 5 and sample No. 11, which each have a concentration of the solution Sa of 60 mass %, respectively show the Haze value H/area size ratio P of 0.233 and 0.205 (0.21), which are in the range of 0.20 or larger. The magnitudes of the Haze value H/area size ratio P correspond to the sizes of the white circles in the optical microscopic images shown in FIG. 4A through FIG. 4C and FIG. 5A through FIG. 5C. Therefore, in order to suppress light scattering from the area around each island of the second region, the Haze value H/area size ratio P is preferably smaller than 0.20, more preferably 0.15 or smaller, and still more preferably 0.10 or smaller.

In order to form the second region having such a value, the concentration of the solution Sa is preferably higher than 60 mass %, more preferably 65 mass % or higher, still more preferably 70 mass % or higher, and yet more preferably 96 mass % or higher. It is possible to use a curable resin composition (liquid) not containing the solvent. However, when the concentration of the solution Sa is 99 mass % or higher, that is, when the concentration of the solution Sa is too high, the light may undesirably scatter excessively. Therefore, the concentration of the solution Sa is preferably lower than 99 mass %, and more preferably 98 mass % or lower. A conceivable reason for this is that when a solvent is contained, even in a small amount, the affinity (wettability) with the porous structure is improved, and therefore, the ease of permeation into the pores of the porous structure with, or the ease of filling the pores with, the curable resin composition is improved. After the curable resin composition permeates the pores of the porous structure, the porous structure may be, for example, dried to remove the remaining solvent. In an optical member in which the second region is formed of a solution containing a curable resin composition and a solvent, the solvent in the second region may not be completely removed and may remain in trace amount even after the optical member is completely produced or even while the optical member is used. The remaining solvent may be detected by, for example, trace mass spectrometry such as, for example, gas chromatography or the like.

Now, examples of components preferably usable in an optical element according to an embodiment of the present invention will be described.

### Waveguide Layer

For the waveguide layer, any of various known waveguide layers (or waveguide materials) may be used. The waveguide layer may be typically formed of a film or a plate-like body of a resin (preferably, a transparent resin). The resin may be a thermoplastic resin or a photocurable resin. Examples of the thermoplastic resin include (meth)acrylic resins such as polymethyl methacrylate (PMMA), polyacrylonitrile and the like; polycarbonate (PC) resins; polyester resins such as PET and the like; cellulose-based resins such as triacetylcellulose (TAC) and the like; cyclic polyolefin-based resins; and polystyrene-based resins. Preferred examples of the photocurable resin include epoxy acrylates-based resins, urethane acrylates-based resins, and the like. These resins may be used independently, or two or more thereof may be used in combination.

The waveguide layer may have a thickness of, for example, 100 μm or greater and 100 mm or less. The thickness of the waveguide layer is preferably 50 mm or less, more preferably 30 mm or less, and still more preferably 10 mm or less.

The waveguide layer has a refractive index n_{GP} in the range of, for example, −0.1 to +0.1 with respect to the refractive index n₃ of the second layer. The lower limit thereof is preferably 1.43 or higher, and more preferably 1. 47 or higher. The upper limit of the refractive index of the waveguide layer is 1.7.

In the case where the first region of the first layer is located so as to be in direct contact with the waveguide layer, the refractive index n_{GP} of the waveguide layer is set such that light is subjected to total internal reflection at an interface between the waveguide layer and the first region of the first layer. In the case where the first region of the first layer is located on the waveguide layer via the second layer, the refractive index N₁ of the first region and the refractive index n₃ of the second layer are set such that light is subjected to total internal reflection at an interface between the second layer and the first region, and the refractive index n_{GP} of the waveguide layer and the refractive index n₂ of the second region are set such that total internal reflection does not easily occur at an interface between the waveguide layer and the second region. It is preferred that |n_{GP}−n₂| is 0.1 or smaller.

As the waveguide layer, a conventional waveguide layer having a concave-convex shape at a surface thereof may be used. Alternatively, a waveguide layer having a substantially flat surface, like the waveguide layer 50 shown in FIG. 1, may be preferably used. The optical member 100 acting as a light coupling layer according to an embodiment of the present invention has a substantially flat main surface, and therefore, may be easily stacked on the waveguide layer 50 having a substantially flat surface and may also be stacked on another optical element having a substantially flat surface. The “substantially flat surface” refers to a surface that does not refract or diffusely reflect light by a concave-convex shape at the surface thereof.

### Porous Layer, First Region of the First Layer

The first layer has a porous structure. The first layer may be formed of a porous layer. The porous layer preferably usable as the first layer contains any of, for example, substantially spherical particles such as silica particles, silica particles including micropores, silica hollow nanoparticles and the like; fibrous particles such as cellulose nanofibers, alumina nanofibers, silica nanofibers, and the like; and flat plate-like particles such as nanoclay formed of bentonite, and the like. In one embodiment, the porous layer is formed of a porous material containing particles (e.g., microporous particles) chemically bonded to each other directly. The particles forming the porous layer may be at least partially bonded to each other via a binder component of a small amount (e.g., an amount equal to, or smaller than, the mass of the particles). The porosity and the refractive index of the porous layer may be adjusted by the particle diameter of the particles forming the porous layer, the particle diameter distribution or the like.

Methods for forming the porous layer include, for example, a method for forming a low-refractive index layer described in WO2019/146628, and also methods described in Japanese Laid-Open Patent Publication No. 2010-189212, Japanese Laid-Open Patent Publication No. 2008-040171, Japanese Laid-Open Patent Publication No. 2006-011175, WO2004/113966, Japanese Laid-Open Patent Publication No. 2017-054111, Japanese Laid-Open Patent Publication No. 2018-123233 Japanese Laid-Open Patent Publication No. 2018-123299, and documents cited in these publications as reference documents. The entirety of all these publications is incorporated herein by reference.

For the porous layer, a porous silica material is preferably usable. A porous silica material is produced by, for example, any of the following methods. The methods include a method of performing hydrolysis and polycondensation of at least one of silicon compounds, hydrolysable silanes and/or silsesquioxane, products obtained as a result of partial hydrolysis thereof, and products obtained as a result of dehydration and condensation thereof; a method using porous particles and/or hollow microparticles; a method of generating an aerogel layer by use of a spring-back phenomenon; a method using a ground gel that is obtained by grinding a gel-like silicon compound obtained by use of a sol-gel method and then chemically bonding microporous particles as the resultant ground particles to each other by use of a catalyst or the like, and the like. Note that the porous layer is not limited to being formed of the porous silica material, and the method for producing the porous layer is not limited to any of the above-described methods. Any production method is usable to form the porous layer. Silsesquioxane is a silicon compound containing RSiO_{1.5} (R is a hydrogen carbonate group) as a basic unit, and is, to be precise, different from silica, which contains SiO₂ as a basic unit. However, silsesquioxane is common to silica in having a network structure having crosslinking via a siloxane bond. Therefore, in this specification, a porous material containing silsesquioxane as a basic unit is also referred to as a “porous silica material” or a “silica-based porous material”.

The porous silica material may be formed of microporous particles, of a gel-like silicon compound, that are bonded to each other. The microporous particles of a gel-like silicon compound may be ground particles of a gel-like silicon compound. The porous silica material may be formed by, for example, coating a substrate with a coating liquid containing ground particles of a gel-like silicon compound. The ground particles of a gel-like silicon compound may be chemically bonded (e.g., siloxane-bonded) to each other by, for example, an action of a catalyst, light radiation, heating or the like.

The lower limit of the thickness of the porous layer (first layer) may be, for example, any thickness greater than the wavelength of the light to be used. Specifically, the lower limit is, for example, 0.3 μm or greater. There is no specific limitation on the upper limit of the thickness of the first layer, but the upper limit is, for example, 5 μm or less, and more preferably 3 μm or less. As long as the thickness of the first layer is within the above-described range, the concave-convex shape at the surface is not sufficiently large to influence the stacking. Therefore, the first layer is easily put into a composite with another member or is easily stacked on another member.

The refractive index of the porous layer, that is, the refractive index n₁ of the first region of the first layer, is preferably 1.30 or lower. With such a refractive index, total internal reflection easily occurs at an interface in contact with the first region; that is, the critical angle may be made small. The refractive index mi of the first region is more preferably 1.25 or lower, still more preferably 1.18 or lower, and especially preferably 1.15 or lower. There is no specific limitation on the lower limit of n₁, but the lower limit is preferably 1.05 or higher from the point of view of mechanical strength.

The lower limit of the porosity of the porous layer, that is, the porosity of the first region of the first layer, is, for example, 40% or greater, preferably 50% or greater, more preferably 55% or greater, and still more preferably 70% or greater. The upper limit of the porosity of the porous layer is, for example, 90% or lower, and more preferably 85% or lower. The porosity is within the above-described range, and this allows the refractive index of the first region to be in an appropriate range. The porosity may be calculated based on the Lorentz-Lorenz's formula from, for example, the value of the refractive index measured by an ellipsometer.

The porous layer, that is, the first region of the first layer, has a film density of, for example, 1 g/cm³ or higher, preferably 10 g/cm³ or higher, and more preferably 15 g/cm³ or higher. By contrast, the film density is, for example, 50 g/cm³ or lower, preferably 40 g/cm³ or lower, more preferably 30 g/cm³ or lower, and still more preferably 2.1 g/cm³ or lower. The range of the film density is, for example, 5 g/cm³ or higher and 50 g/cm³ or lower, preferably 10 g/cm³ or higher and 40 g/cm³ or lower, and more preferably 15 g/cm³ or higher and 30 g/cm³ or lower. Alternatively, the range is, for example, 1 g/cm³ or higher and 2.1 g/cm³ or lower. The film density may be measured by any known method.

### Second Region of the First Layer

The second region of the first layer is formed of a cured resin composition filling the pores included in the porous layer. The refractive index n₂ of the second region, the refractive index n₁ of the first region and the refractive index n₃ of the second layer fulfill the relationships of n₁<n₂ and n₁<n₃. n₂ fulfills these relationships, and this may suppress light scattering caused by the reflection and refraction of light at an interface, in the planar direction, between the first region and the second region of the first layer. The lower limit of n₂ is, for example, higher than 1.30, preferably 1.35 or higher, and more preferably 1.40 or higher.

The first region and the second region of the first layer are formed of a common porous layer. That is, the first layer has a continuous porous structure in the entirety of the first region and the second region. Where a material forming a matrix portion of the porous layer (the matrix portion is a portion other than the pores of the porous layer) has a refractive index n_{M}, the refractive index of the porous layer, that is, the refractive index n₁ of the first region, is determined by n_{M}, the porosity and the refractive index of air, and the refractive index n₂ of the second region is determined by n_{M}, the porosity, the refractive index n₃ of the second layer (resin composition), and the ratio at which the pores are filled with the resin composition. In the case where, for example, a porous silica material is used for the porous layer as described above, n_{M} is, for example, 1.41 or higher and 1.43 or lower. In the case where the refractive index of the resin is higher than n_{M} (e.g., in the case where the refractive index of the resin is 1.45 or higher and 1.70 or lower), the relationship of n₁<n₂<n₃ is provided.

Examples of preparing a coating liquid (liquid containing microporous particles) for formation of the porous layer (first region of the first layer)

### (1) Gelation of a Silicon Compound

0.95 g of methyltrimethoxysilane (MTMS), as a precursor of a gel-like silicon compound, was dissolved in 2.2 g of dimethylsulfoxide (DMSO) to prepare a mixture liquid A. 0.5 g of aqueous solution of oxalic acid having a molar concentration of 0.01 mol/L was incorporated into the mixture liquid A, and the resultant substance was stirred at room temperature for 30 minutes to hydrolyze MTMS. As a result, a mixture liquid B containing tris(hydroxy)methylsilane was generated.

0.38 g of ammonia water having a concentration of 28 mass % and 0.2 g of pure water were incorporated into 5.5 g of DMSO, and then the mixture liquid B was incorporated thereto. The resultant substance was stirred at room temperature for 15 minutes to gelate tris(hydroxy)methylsilane. As a result, a mixture liquid C silicon containing a gel-like compound (polymethylsilsesquioxane) was obtained.

### (2) Maturing Process

The mixture liquid C containing the gel-like silicon compound prepared as described above was incubated as it was at 40° C. for 20 hours. As a result, the mixture liquid C was matured.

### (3) Grinding Process

Next, the gel-like silicon compound matured as described above was ground into granules having a size of several millimeters to several centimeters by use of a spatula. Next, 40 g of isopropyl alcohol (IPA) was incorporated into the mixture liquid C. The resultant substance was stirred lightly and kept still at room temperature for 6 hours. Then, the solvent and the catalyst in the gel were decanted. Similar decantation was performed three times to realize solvent displacement. As a result, a mixture liquid D was obtained. Next, the gel-like silicon compound in the mixture liquid D was ground (by high-pressure no-medium grinding). The grinding process (high-pressure no-medium grinding) was performed as follows. A homogenizer (trade name “UH-50” produced by SMT Co., Ltd.) was used. 1.85 g of the gel-like compound and 1.15 g of IPA in the mixture liquid D were weighed and put into a 5 cc screw bottle, and then ground for 2 minutes under the conditions of 50 W and 2 kHz.

The gel-like silicon compound in the mixture liquid D was ground by the grinding process, and the resultant mixture liquid D′ became a sol liquid of the ground particles. The volume-average particle diameter, showing the dispersion in the particle size of the ground particles contained in the mixture liquid D′ was checked by a dynamic light scattering nano track particle size analyzer (UPA-EX150 produced by Nikkiso Co., Ltd.). The volume-average particle diameter was 0.50 to 0.70. In addition, to 0.75 g of the sol liquid (mixture liquid C′), 0.062 g of MEK (methylethylketone) solution of a photo base generator (trade name “WPBG266” produced by Wako Pure Chemical Industries, Ltd.) having a concentration of 1.5 mass %, and 0.036 g of MEK solution of bis(trimethoxysilyl)ethane having a concentration of 5% were added in proportion. As a result, a coating liquid for formation of a porous layer (liquid containing microporous particles) was obtained. The coating liquid for formation of a porous layer contains a porous silica material containing silsesquioxane as a basic structure.

A surface of an acrylic resin film (thickness: 40 μm) prepared according to production example 1 of Japanese Laid-Open Patent Publication No. 2012-234163 was coated with the above-described coating liquid to form a coating film. The coating film was dried at a temperature of 100° C. for 1 minute, and the post-drying coating film was irradiated with ultraviolet rays of a light radiation amount (energy) of 300 mJ/cm² by use of light having a wavelength of 360 nm. As a result, a stacked body including the acrylic resin film and a porous layer (porous silica material obtained as a result of a chemical bond of silica microporous particles) formed on the acrylic resin film was obtained (acrylic film with the porous silica layer was obtained). The porous layer had a refractive index of 1.15.

By use of the optical member according to an embodiment of the present invention, optical elements as follows, for example, may be obtained.

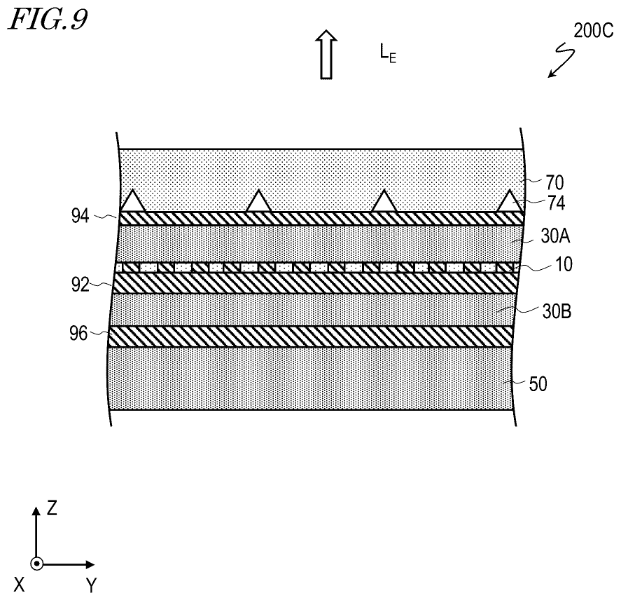

FIG. 7 is a schematic cross-sectional view of an optical element 200A according to an embodiment of the present invention. FIG. 8 is a schematic cross-sectional view of an optical element 200B according to an embodiment of the present invention. FIG. 9 is a schematic cross-sectional view of an optical element 200C according to an embodiment of the present invention.

The optical elements 200A through 200C shown in FIG. 7, FIG. 8, and FIG. 9 each include the first layer 10, a substrate layer 30A and/or 30B, a patterned film 70, and an adhesive layer 92, 94 and/or 96. The patterned film 70 and the adhesive layer 94 form a direction conversion layer including a plurality of inner spaces 74.

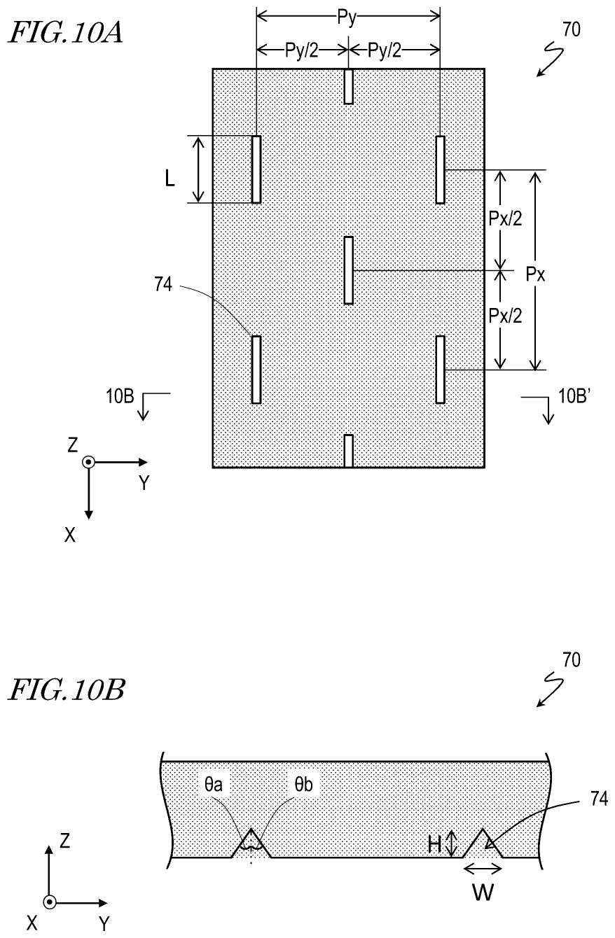

As the patterned film 70, for example, a concave-convex patterned film shown in FIG. 10A and FIG. 10B may be used.

FIG. 10A is a plan view of a part of the concave-convex patterned film 70 as seen from the plane having the concaved and convexed portions. FIG. 10B is a cross-sectional view of the concave-convex patterned film taken along line 10B-10B′ in FIG. 10A. A plurality of concaved portions 74 each having a triangular cross-section having a length L of 80 μm, a width W of 14 μm, and a depth H of 10 μm were located with an interval of a width E (155 μm) in an X-axis direction. The concaved portions 74 having such a pattern were located with an interval of a width D (100 μm) in a Y-axis direction. The concaved portions 74 were located in a surface of the concave-convex patterned film at a density of 3612 pieces/cm². In FIG. 10B, θa and θb were each 41 degrees. When the film was seen from the plane having the concaved and convexed portions, the concaved portions 74 had an area size occupancy ratio of 4.05% with respect to the film.

Such a concave-convex patterned film may be produced by a method described in PCT Japanese National-Phase Laid-Open Patent Publication No. 2013-524288. Specifically, a surface of a polymethylmethacrylate (PMMA) film was coated with a lacquer (Fine Cure RM-64: acrylate-based photocurable resin produced by Sanyo Chemical Industries, Ltd.), and an optical pattern was embossed on a surface of the film containing the lacquer. Then, the lacquer was cured (e.g., under the ultraviolet radiation conditions: D bulb, 1000 mJ/cm², 320 mW/cm²) to produce an intended concave-convex patterned film. The concave-convex patterned film had a total thickness of 130 μm and a Haze value of 0.8%.

As described above, a configuration in which stack bodies stacked on a plurality of substrate layers are bonded to each other via an adhesive layer) is adopted, so that it is possible to mass-produce an optical element by a roll-to-roll method or a roll-to-sheet method.

The substrate layers 30A and 30B each independently have a thickness of, for example, 1 μm or greater and 1000 μm or less, preferably 10 μm or greater and 100 μm or less, and still more preferably 20 μm or greater and 80 μm or less. The substrate layers 30A and 30B each independently have a refractive index of preferably 1.40 or higher and 1.70 or lower, and more preferably 1.43 or higher and 1.65 or lower.

The adhesive layers 92, 94, and 96 each independently have a thickness of, for example, 0.1 μm or greater and 100 μm or less, preferably 0.3 μm or greater and 100 μm or less, and more preferably 0.5 μm or greater and 50 μm or less. The adhesive layers 92, 94, and 96 each independently have a refractive index of preferably 1.42 or higher and 1.60 or lower, and more preferably 1.47 or higher and 1.58 or lower.

It is preferred that the refractive index of each of the adhesive layers 92, 94, and 96 is close to the refractive index of the waveguide layer 50 or the patterned film 70 to be in contact therewith, and it is preferred that the absolute value of the difference between the refractive indices is 0.2 or smaller.

In the case where such an optical element is mass-produced by the roll-to-roll method or the roll-to-sheet method, it is preferred that the transfer step described above with reference to FIG. 3C is performed at a laminate pressure of 0.3 MPa or lower. If the laminate pressure in the step of transferring the solution Sa on the transfer substrate (film) 30T onto the porous layer 10P exceeds 0.3 MPa, there is a risk that the white areas formed around the islands of the second region formed of the resin composition filling the pores included in the porous structure may be enlarged. When the white areas are enlarged (that is, when the H/P value is increased), the light distribution of the light emitted from the optical element is shifted from a desired distribution. For example, when the white areas are enlarged, the directivity of the light emitted from the optical element is decreased, and the half-power angle (full width at half maximum) of the output light is increased. In the above-described experiment examples, the transfer step was performed by use of a hand roller (laminate pressure: lower than 0.1 MPa).

Optical element samples having the same configuration as that of the optical element 200A shown in FIG. 7 were produced with different laminate pressures in the transfer step, and the half-power angles of the output light were measured. As the patterned film 70, the patterned film 70 described above with reference to FIG. 10A and FIG. 10B was used. The formation of the first layer 10 was performed under the same conditions as those of sample No. 8 except for the laminate pressure (the laminate pressure for sample No. 8 was 0.0 MPa). As the laminator, a roll laminator (LPA330 produced by Fujipla Co., Ltd.) was used. The laminate pressures were measured by prescales (for extremely low pressures (4LW) and for ultra super low pressures (LLLW); produced by FUJIFILM Corporation). The laminate pressures were 0.3 MPa (sample No. 8A) and 0.6 MPa (sample No. 8B).

An LED light source was located at an end of the waveguide layer 50 of each of the obtained optical element samples, and the light distributions of the output light L_{E} were measured (see FIG. 1 and FIG. 7). The light distributions were measured by use of an imaging chromaticity meter (ProMetric I-Plus produced by RADIANT Vision Systems). The measured area had an area size of 35 mm square (the same size as that of the detector lens). The half-power angle of the output light L_{E} was calculated from each of the measured light distributions.

The half-power angle of optical element sample No. 8 was 27 degrees, the half-power angle of optical element sample No. 8A was 30 degrees, and the half-power angle of optical element sample No. 8B was 32 degrees. It is seen that as the laminate pressure in the transfer step is higher, the half-power angle is larger and the directivity of the output light is lowered. For example, in order to provide a half-power angle of 30 degrees or smaller, it is preferred that the laminate pressure is 0.3 MPa or lower.

### Industrial Applicability

The optical member according to the present invention is included in, for example, an optical element (light distribution element) together with a waveguide layer or the like, and is applicable for, for example, public or general illumination devices such as front lights, backlights, illumination devices for windows/facades, signage, traffic signals, window illumination devices, wall illumination devices, tabletop illumination devices, solar applications, decorative illumination devices, light shields, light masks, roof lighting and the like. For example, the optical member according to the present invention is preferably usable as a component of a front light of a reflective display, which is an example of signage. Use of the optical member according to the present invention allows an image or graphics on the reflective display to be viewed with no optical defect such as visible blur or the like, which would be caused by scattered or diffracted light.

### REFERENCE SIGNS LIST

10: first layer; 12: first region; 14: second region; 30: substrate layer; 50: waveguide layer; 70: concave-convex patterned film; 74: concaved portion (inner space); 200A, 200B, 200C: optical element

1. An optical member, comprising:
a first layer having a porous structure,
wherein the first layer includes a first region having the porous structure and a second region formed of a resin composition filling pores included in the porous structure,
wherein the second region includes a plurality of island-like regions discretely located, and
wherein where the second region occupies an area size ratio of P % of the first layer and the first layer has a Haze value of H %, an H/P value is smaller than 0.20.

2. The optical member of claim 1, wherein a diameter of a circle having an equal circumference to that of each of the plurality of island-like regions is about 1 μm or longer and about 500 μm or shorter.

3. The optical member of claim 1, wherein the resin composition contains a curable resin composition in a cured state.

4. The optical member of claim 3, wherein the resin composition contains a polyfunctional silicon compound.

5. The optical member of claim 3, wherein the resin composition contains an acrylic resin.

6. The optical member of claim 3, wherein the resin composition further contains a solvent.

7. The optical member of claim 1, further comprising a second layer in contact with a first main surface of the first layer, wherein where the first region has a refractive index of n₁, the second region has a refractive index of n₂ and the second layer has a refractive index of n₃, n₁<n₂ and n₁<n₃.

8. The optical member of claim 7, wherein n₁ is 1.30 or lower, and n₂ is 1.43 or higher.

9. The optical member of claim 7, wherein the second layer is an adhesive layer or a substrate layer.

10. The optical member of claim 1, wherein the first layer contains a porous silica material.

11. An optical element, comprising:
the optical member of claim 1; and
a waveguide layer.

12. The optical element of claim 11, further comprising a direction conversion layer located on a side opposite to the waveguide layer across the optical member.

13. A method for producing an optical member, comprising:
preparing a porous layer;
forming a plurality of discrete island-like regions of a solution Sa, containing a curable resin composition, on the porous layer, the solution Sa having a concentration higher than 60 mass % and lower than 99 mass %;
filling pores included in the porous layer with the solution Sa; and
curing the curable resin composition contained in the solution Sa in the pores.

14. The method for producing the optical member of claim 13, wherein the forming includes forming the plurality of discrete island-like regions of the solution Sa on a film, and transferring the solution Sa on the film onto the porous layer.

15. The method for producing the optical member of claim 14, wherein the transferring is performed at a laminate pressure of 0.3 MPa or lower.

16. The method for producing the optical member of claim 13, wherein the forming includes forming the plurality of discrete island-like regions of the solution Sa on an adhesive layer, and transferring the solution Sa on the adhesive layer onto the porous layer.

17. The method for producing the optical member of claim 16, wherein the forming includes forming the plurality of discrete island-like regions of the solution Sa on a film, and transferring the solution Sa on the film onto the adhesive layer.

18. The method for producing the optical member of claim 13, wherein the forming the plurality of discrete island-like regions of the solution Sa includes forming the plurality of discrete island-like regions of a solution Sb containing the curable resin composition at a concentration of 60 mass % or lower, and removing a part of a solvent contained in the solution Sb.
